(19) United States
(12) Patent Application Publication
(10) Pub. No.: US 2024/0422256 A1
(43) Pub. Date: Dec. 19, 2024

(54) Headset Communication Device

(71) Applicant: Cornelius Brown, Chicago, IL (US)

(72) Inventor: Cornelius Brown, Chicago, IL (US)

(21) Appl. No.: 18/733,968

(22) Filed: Jun. 5, 2024

Related U.S. Application Data
(60) Provisional application No. 63/508,041, filed on Jun. 14, 2023.

(51) Int. Cl. H04M 1/05

(52) U.S. Cl. CPC H04M 1/05

(57) ABSTRACT

The present invention relates to a headset communication device and system. The communication device features a headset configured to be worn on a head by a user and has a plurality of straps, each strap offering a non-overlapping and non-cellular frequency from which a specific frequency can be selected for communication with other users wearing the same device and configured to the same frequency channel. The device includes an earpiece speaker, a microphone, and a control unit equipped with volume and channel controls. An antenna broadcasts the voice messages captured by a microphone using the selected frequency and users wearing the device tuned to the same frequency receive the voice messages for facilitating the communication without using any cellular network.

### CROSS-REFERENCE TO RELATED APPLICATION

The present application claims priority to, and the benefit of, U.S. Provisional Application No. 63/508,041, which was filed on Jun. 14, 2023, and is incorporated herein by reference in its entirety.

### FIELD OF THE INVENTION

The present invention relates generally to the field of radio transmission. More specifically, the present invention relates to a novel headset communication device that is configured to facilitates communication between a group of individuals without using a cell phone, computer, radio, and more. The device is designed to offer an alternative to cell phone communication and is worn as a headset by a user. A plurality of non-cellular communication channels is provided by the device from which any one can be chosen for communicating with other users wearing the devices configured to the same frequency channel. Accordingly, the present disclosure makes specific reference thereto. Nonetheless, it is to be appreciated that aspects of the present invention are also equally applicable to other like applications, devices, and methods of manufacture.

### BACKGROUND

By way of background, mobile phone converts voice, text, multi-media messages or data calls into Radio Frequencies (RF). Mobile phone base stations transmit and receive these RF signals and connect callers to other phones and other networks. Cellular network is most commonly the native connectivity method deployed with most cell phones, smartphones, and dial-up devices. It is a mobile-based network used with a radio antenna. For providers, the cost of setting up cellular network infrastructure is higher. The capacity is lower and depends on channel/multiple access techniques employed to serve subscribers. Physical obstruction, climatic conditions, and inclement weather all have an effect on wireless communication. Using cellular data is expensive for consumers and many times, individuals also face unavailability of cellular networks. Cellular network is costly mainly because of licensing expense for bandwidth/spectrum as well as in technology. Further, the costs to maintain infrastructure is enormous. Consumers are required to typically pay for a monthly cellular data allowance for access to the network. As a result, individuals desire a cost effective and efficient way of communicating to each other.

Many individuals use conventional walkie-talkies for communication. Walkie-talkies are two-way mobile communication tools which can talk to each other without the support of any radio communication network and extra charges. However, conventional walkie-talkies are inefficient at facilitating long distance communication and further, are difficult to communicate with a plurality of individuals simultaneously. Individuals generally face a great deal of interference and noise in conventional walkie-talkies.

Therefore, there exists a long-felt need in the art for a communication system that reduces dependency on expensive cellular connections and networks for communication. There is also a long-felt need in the art for a communication device and system that facilitate communication between a group of individuals without using a cell phone, a computer, a radio, and other similar mechanisms. Additionally, there is a long-felt need in the art for a communication device that is cost-effective and easy to use. Moreover, there is a long-felt need in the art for a communication system that improves convenience and enables a user to communicate with multiple individuals simultaneously. Further, there is a long-felt need in the art for an improved communication device that overcomes the shortcomings of conventional walkie-talkies. Furthermore, there is a long-felt need in the art for a communication device that enables users to select a specific communication frequency for long distance communication. Finally, there is a long-felt need in the art for a device that can be easily worn and used by users and provides an alternative to cell phone communication.

The subject matter disclosed and claimed herein, in one embodiment thereof, comprises a headset communication system for enabling communication between a group of individuals without using a cell phone, computer, radio, or any other mechanism. The system features a headset configured to comfortably clip to the head of a user via silicone straps, each strap is connected to a common antenna and is configured to provide a non-overlapping frequency communication channel, the frequency is configured for a long distance communication, a microphone for capturing audio of the user wearing the device, a control unit equipped with volume control buttons and channel frequency control, an earpiece speaker for playing out sound received by the antenna, wherein the captured audio is transmitted by the antenna on a communication channel having the frequency of a strap selected using the channel frequency control. A plurality of devices can be configured to a common frequency communication channel for enabling communication among a set of individuals without using any cellular network.

In this manner, the headset communication system of the present invention accomplishes all of the forgoing objectives and provides users with a communication system featuring multiple wireless communication channels embedded into a headset that enables individuals to select a communication channel via a frequency and be heard by other individuals wearing the headset tuning into the same frequency. The device does not use expensive cellular networks and provides an advantage of having long distance communication that is not possible in conventional walkie-talkies.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a headset communication system configured to function like a radio or walkie-talkie for enabling communication between a group of individuals without using a cell phone, computer, radio, or any other mechanism. The system is in the form of a headset device configured to be worn on a head of a user, the headset has a plurality of silicone straps, each strap is connected to a common antenna and is configured to provide a non-overlapping frequency communication channel, a microphone for capturing audio of the user wearing the device, a control unit equipped with volume control buttons and channel frequency control, an earpiece speaker for playing out sound received by the antenna, wherein the captured audio is transmitted by the antenna on a communication channel having frequency of a strap selected using the channel frequency control. The device can be individually worn by a group or plurality of users wherein a set of users wearing the devices configured to a common frequency communication channel communicate and listen to each other without using any cellular network. The device enables individuals to select a communication channel via a frequency and to communicate with at least another individual wearing another headset tuning into the same frequency.

In yet another embodiment, a headset communication device is disclosed. The device comprising a plurality of straps, each strap is configured to provide a communication channel, the communication channel has a non-overlapping frequency, a radio frequency antenna configured to establish radio frequency communication with other headset communication devices on a selected non-overlapping frequency, a microphone for capturing a user voice while the user is wearing the headset communication device wherein the antenna is configured to broadcast the user voice on the non-overlapping frequency, and receiving the broadcasted user voice by the antennas of other headset communication devices tuned to the non-overlapping frequency for facilitating the communication.

In yet another embodiment, a method for communicating by a user with other users without using a cell phone is described. The method includes the steps of providing a communicating device, the device includes a headset that comfortably clips to the head of the user via silicone straps, each silicone strap is configured to provide an exclusive frequency for communication, a microphone for capturing voice, a speaker for playing out received sound, an antenna for broadcasting voice at a selected exclusive frequency; receiving, by the microphone, a voice of the user wearing the device; receiving, by the antenna, voice from the microphone; broadcasting, by the antenna, received voice at the selected exclusive frequency; receiving, by the other devices tuned to the same exclusive frequency, the broadcasted voice; playing out received broadcasted voice with the speakers of the devices, the received voice for completing the communication.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a wearable headset communication system of the present invention in accordance with the disclosed architecture;

FIG. 2 illustrates a flow diagram depicting a process for communication of a user wearing the communication device with other users wearing other similar communication devices operating on the same channel in accordance with the disclosed architecture;

FIG. 3 illustrates a functional block diagram of the headset communication device of the present invention in accordance with the disclosed architecture; and

FIG. 4 illustrates a perspective view of a user wearing the headset communication device of the present invention for communication with other users in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a communication system that reduces dependency on expensive cellular connections and cellular networks for communication. There is also a long-felt need in the art for a communication device and system that facilitate communication between a group of individuals without using a cell phone, a computer, a radio, and other similar mechanisms. Additionally, there is a long-felt need in the art for a communication device that is cost-effective and easy to use. Moreover, there is a long-felt need in the art for a communication system that improves convenience and enables a user to communicate with multiple individuals simultaneously. Further, there is a long-felt need in the art for an improved communication device that overcomes the shortcomings of conventional walkie-talkies. Furthermore, there is a long-felt need in the art for a communication device that enables users to select a specific communication frequency for long distance communication. Finally, there is a long-felt need in the art for a device that can be easily worn and used by users and provides an alternative to cell phone communication.

The present invention, in one exemplary embodiment, is a headset communication device. The device comprising a plurality of straps, each strap is configured to provide a communication channel, the communication channel has a non-overlapping frequency, a radio frequency antenna configured to establish radiofrequency communication with other headset communication devices on a selected non-overlapping frequency, a microphone for capturing a user voice while the user is wearing the headset communication device wherein the antenna is configured to broadcast the user voice on the non-overlapping frequency, and receiving the broadcasted user voice by the antennas of other headset communication devices tuned to the non-overlapping frequency for facilitating the communication.

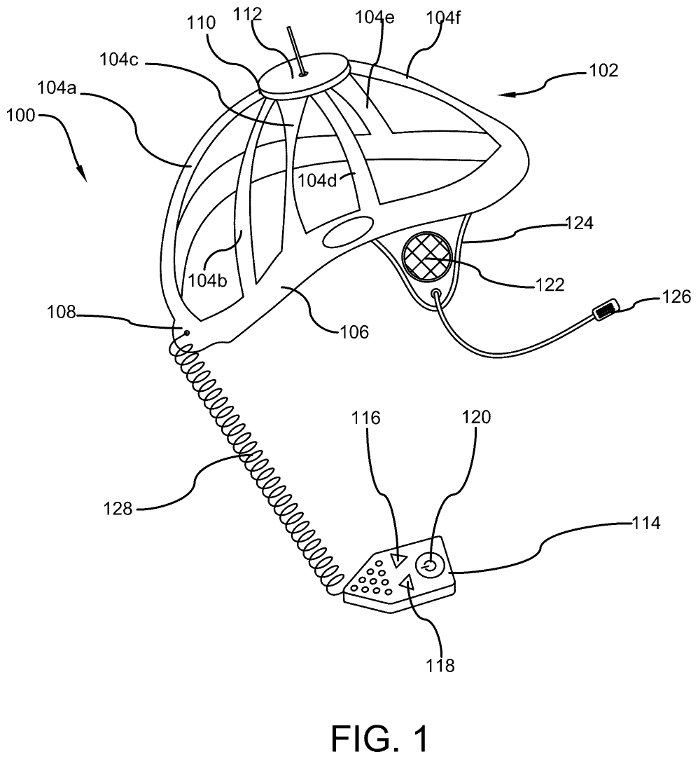

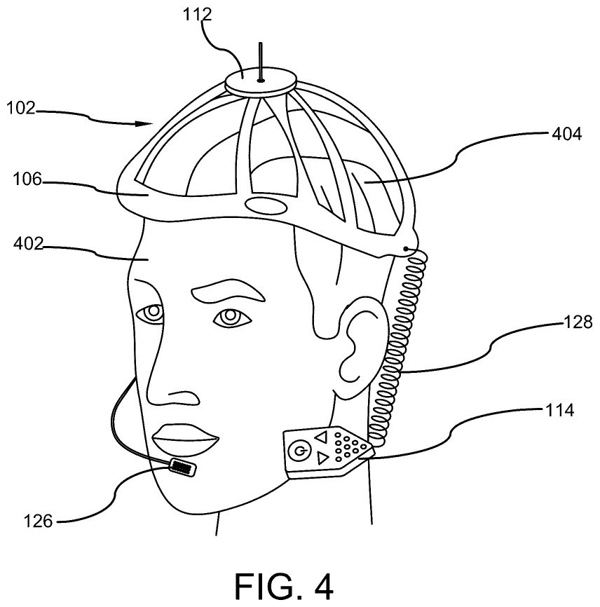

Referring initially to the drawings, FIG. 1 illustrates a perspective view of one potential embodiment of a wearable communication system of the present invention in accordance with the disclosed architecture. The wearable communication system 100 of the present embodiment is designed to function similar to a radio or walkie-talkie for enabling individuals to communicate with each other (i.e., wireless two-way communication) wirelessly without using expensive cellular or internet connections. The communication device 100 features a headset 102 configured to comfortably cover a portion of the head of a user as illustrated in FIG. 4. The headset 102 includes a plurality of silicone straps 104a-f, each silicone strap extending between a point on the periphery 106 of the headset 102 to the antenna 112. As illustrated, the strap 104a extends between the point 108 on the periphery 106 and point 110 on the antenna 112.

Each silicone strap of the device 100 functions as a separate communication channel providing an independent and non-overlapping frequency enabling the device 100 to be used as a communication device for communication with other similar devices working or configured on the same communication channel. The silicone straps 104a-f are connected to a multipurpose antenna 112 that is tuned to a selected frequency of a particular strap for enabling transmission of radio waves for facilitating communication.

A control unit 114 is connected to the headset 102 and includes a pair of volume control buttons 116, 118. The volume control button 116 is used for increasing a speaker volume and the button 118 is used for decreasing the speaker volume. For selecting a specific communication channel for communication, a channel control 120 is provided on the control unit 114 and is used for tuning the antenna to receive and transmit a specific and non-overlapping communication frequency. The channel control 120 can be in the form of a knob that can be rotated to tune the antenna 112 to a particular frequency. An earpiece speaker 122 disposed on an car flap 124 is used for playing or emitting the sound received by a device 100 on the selected specific frequency channel for communication. The speaker 122 may utilize one or more appropriate noise cancelling algorithms. The device can include manually or automatically adjusting parameters and/or coefficients of an algorithm, resulting in a change to the manner in which the algorithm suppresses noise.

A microphone 126 is coupled to the car flap 124 for amplifying and converting audio signals of a user wearing the device 100 into electrical signals for transmitting as radio waves through the antenna 112 for facilitating the communication with other users wearing the same device 100 tuned to the same frequency channel. The microphone 126 can be a directional microphone, a microphone array, an omni-directional microphone, a miniature or MEMS microphone or similar.

The device 100 may also implement one or more digital signal processors and/or adaptive filters operating on ambient, directional, or directionless, source and noise audio in order to enhance delivery of desirable audio of a user and damp delivery of undesirable audio such as surrounding noise. The device 100 may also compensate or adjust for inclement listening environments, such as that experienced by a user in a moving vehicle with the windows down or in a concert or theater. The device 100 adjusts the filtration of sound based on the frequency of channel selected for operating the device 100 and direction and power of the surrounding noise.

The periphery 106 of the headset 102 is soft, clastic, and adjustable to fit to head of different sizes. Further, the control unit 114 is connected to the periphery 106 through an extendable spiral cord 128 enabling the control unit 114 to adjust as per preferences of a user wearing the communication device 100.

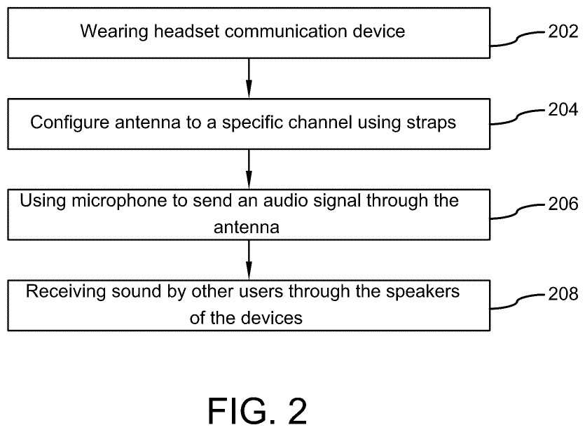

FIG. 2 illustrates a flow diagram depicting a process for communication of a user wearing the communication device with other users wearing the device operating on the same channel in accordance with the disclosed architecture. Individual headset communication devices are initially worn by individuals wanting to communicate without using expensive cellular connection (Step 202). Thereafter, individuals configure antenna of their respective devices to a particular frequency using the channel control of the control unit (Step 204). The devices configured to the same frequency channel communicate with each other (i.e., wireless two-way communication) and a user uses the microphone to send audio signals for communication (Step 206). The speakers of the other devices connected to the device of the user speaking simultaneously receive the sound or audio for completing the communication without using any cellular channels (Step 208).

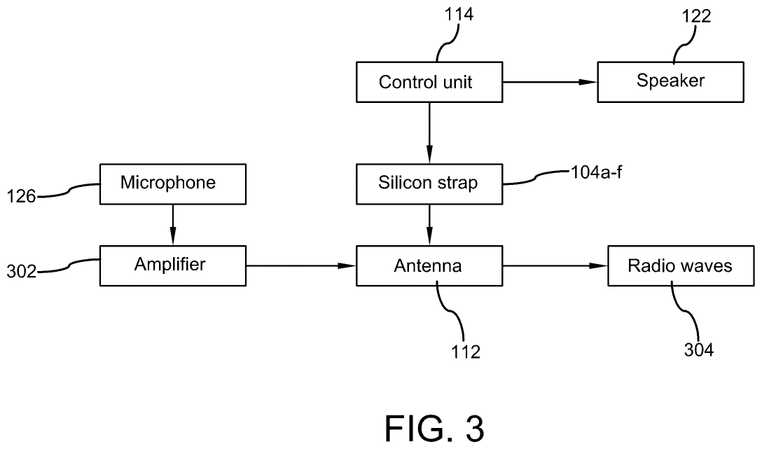

FIG. 3 illustrates a functional block diagram of the headset communication device 100 of the present invention in accordance with the disclosed architecture. The microphone 126 is coupled to an amplifier 302 for amplifying sound received by the microphone 126. The amplifier 302 can be built into the microphone 126 in some of the embodiments of the present invention. The amplified audio electric signals are transmitted to the antenna 112 through a silicone strap of a specific frequency selected by a user using the control unit 114. Each silicone strap 104a-f can include a frequency oscillator each for transmitting an audio signal in specific frequency band.

The control unit 114, in one exemplary embodiment, enables the user to select one of the six frequencies available for communication with other users. Additionally, the control unit 114 is also used for controlling and operating the speaker 122 of the device 100. The antenna 112 is configured to transmit as well as receive the audio signals in the form of radio waves 304 that correspond to the frequency of the selected silicone strap of the device 100.

The speaker 122 can include one or more analog to digital converters (ADCs) and/or one or more digital to analog converters (DACs). In certain embodiments, the speaker 122 can include one or more general purpose processors and/or digital signal processors that receives a digitally converted signal corresponding to the audio.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

FIG. 4 illustrates a perspective view of a user wearing the headset communication device of the present invention for communication with other users in accordance with the disclosed architecture. As illustrated, the headset 102 is worn by a user 402 on the head 404 such that the clastic and adjustable periphery circumscribes to the head 404 with the antenna 112 positioned on the top of the head 404. The microphone 126 can be adjusted to position near the mouth 406 of the user 402 for effectively capturing audio of the user 402.

The control unit 114 of the device 100 can be adjusted as per preferences of the user using the flexible cord 128 enabling access to operate and control the speaker 122 and silicone straps 104a-f. The electric circuitry disposed inside the headset 102 is insulated and weatherproof, enabling the user 402 to use the device 100 in inclement weather. The device 100 may have an integrated battery (not shown) that can be recharged and replaced as required by the user 402.

It should be noted that the device 100 can come in different sizes and different shapes and designs of the silicone straps to fit users of different age and genders. In one exemplary arrangement, the headset 102 and silicone straps 104a-f can be affixed to the inside of a cap or hat (i.e., baseball cap). Further, the device 100 does not require any cellular connection or Wi-Fi connection for communication, thereby the device can work in remote areas. The device 100 enables a user to communicate with a group of individuals simultaneously without any delay or lag, thereby providing substantial improvement over conventional cell phones.

In one embodiment, the communication device 100 can use frequency based on an ISM (industrial scientific and medical) band and can send a signal without paying a separate frequency utilization cost. Here, the ISM band is a frequency band that is used for an industrial, scientific, and medical purpose.

Example 1: In the present example, the device 100 is used for personal radio service and is not intended for business use. The device 100 uses frequencies around and between 462 MHz and 467 MHz in the UHF (ultra-high frequency) band. The device 100 in the present example can be used for communication in a distance range from about 0.5 km to about 1.5 km (0.3 to 1 mile).

Example 2: The device 100 in the present example operates at 136-174 MHZ. Use of longer radio waves in the present example enables the device to cover a greater distance range with less power. This is useful for outdoor areas with fewer obstacles.

Example 3: The device 100 in the present example operates at 400-512 MHz. This is useful for indoor areas and is also preferred for outdoor urban settings with many obstructions and areas that are hilly or have a lot of trees.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “headset communication device”, “communication device”, “device”, and “headset communication system” are interchangeable and refer to the headset communication system 100 of the present invention.

Notwithstanding the forgoing, the headset communication system 100 of the present invention can be of any suitable size and configuration as is known in the art without affecting the overall concept of the invention, provided that it accomplishes the above-stated objectives. One of ordinary skill in the art will appreciate that the headset communication system 100 as shown in the FIGS. are for illustrative purposes only, and that many other sizes and shapes of the headset communication system 100 are well within the scope of the present disclosure. Although the dimensions of the headset communication system 100 are important design parameters for user convenience, the headset communication system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wearable communication device for wireless two-way communication comprising:
a wearable headset;
a plurality of silicone straps;
an antenna;
a control unit;
an earpiece speaker, and
a microphone;
wherein said antenna tuned to a selected frequency for transmission of radio waves;
wherein each of said plurality of silicone straps are connected to said antenna;
wherein each of said plurality of silicone straps having a unique frequency for said transmission of said radio waves;
wherein each said silicone strap having a separate communication channel frequency device for communication with other similar devices working on the same communication channel; and
further wherein transmission of said radio waves of one of said wearable communication device received by another of said wearable communication device.

2. The wearable communication device of claim 1, wherein each said silicone strap extending from a unique position on a periphery of said wearable headset to said antenna.

3. The wearable communication device of claim 2, wherein said control unit having a pair of volume control buttons for controlling the volume of said earpiece speaker, and a channel control for tuning said antenna and selecting a specific communication channel for communication.

4. The wearable communication device of claim 3, wherein said channel control having a control unit for tuning said antenna for said transmission and said receiving of a selectable frequency of said radio wave.

5. The wearable communication device of claim 4, wherein said earpiece speaker attached to an ear flap for emitting a sound received by said wearable communication device.

6. The wearable communication device of claim 5, wherein said microphone attached to said ear flap for converting audio signals of a user wearing said wearable communication device into electrical signals for said transmission of said radio waves through said antenna.

7. The wearable communication device of claim 6, wherein said microphone is selected from a group consisting of a directional microphone, a microphone array, an omni-directional microphone, a miniature microphone, and a MEMS microphone.

8. The wearable communication device of claim 7 further comprising a spiral cord connecting said control unit to said periphery of said wearable headset.

9. The wearable communication device of claim 8, wherein said periphery of said wearable headset is elastic.

10. A wearable communication device for wireless two-way communication comprising:
a wearable headset;
a plurality of silicone straps;
an antenna;
a control unit;
an earpiece speaker; and
a microphone;
wherein said antenna tuned to a selected frequency for transmission of radio waves;
wherein each of said plurality of silicone straps are connected to said antenna;
wherein each of said plurality of silicone straps having a unique frequency for said transmission of said radio waves;
wherein each said silicone strap having a separate communication channel frequency device for communication with other similar devices working on the same communication channel;
wherein transmission of said radio waves of one of said wearable communication device received by another of said wearable communication device; and
further wherein said channel control having a control unit for tuning said antenna for said transmission and said receiving of a selectable frequency of said radio waves.

11. The wearable communication device of claim 10, wherein said control unit having a pair of volume control buttons for controlling the volume of said earpiece speaker, and a channel control for tuning said antenna and selecting a specific communication channel for communication.

12. The wearable communication device of claim 11, wherein said microphone attached to said ear flap for converting audio signals of a user wearing said wearable communication device into electrical signals for said transmission of said radio waves through said antenna.

13. The wearable communication device of claim 12, wherein said microphone is selected from a group consisting of a directional microphone, a microphone array, an omni-directional microphone, a miniature microphone, and a MEMS microphone.

14. The wearable communication device of claim 13 further comprising a spiral cord connecting said control unit to said periphery of said wearable headset.

15. The wearable communication device of claim 14, wherein said periphery of said wearable headset is elastic.

16. A method for wireless two-way communication between users, the method comprising the steps of:
wearing a first headset on a head of a first user a wearable communication device having a plurality of silicone straps, an antenna, a control unit, an earpiece speaker, and a microphone;
wearing a second headset on a head of at least a second user a wearable communication device having a plurality of silicone straps, an antenna, a control unit, an earpiece speaker, and a microphone;
selecting a frequency for transmission of radio waves;
tuning said first antenna of said first user and said second antenna of said second user to said selected frequency;
wherein respective each of said plurality of silicone straps are connected to said antenna;
wherein respective each of said plurality of silicone straps having a unique frequency for said transmission of said radio waves;
wherein respective each said plurality of silicone strap having a separate communication channel frequency device for communication between said first headset and said second headset;
transmitting said radio waves from said first headset to said second headset;
receiving said radio waves to said second headset; and
further wherein said channel control having a control unit for tuning said antenna for said transmitting and said receiving of a selectable frequency of said radio waves from said first headset to said second headset.

17. The wearable communication device of claim 16, wherein each said silicone strap extending from a unique position on a periphery of said wearable headset to said antenna.

18. The wearable communication device of claim 17, wherein said control unit having a pair of volume control buttons for controlling the volume of said earpiece speaker.

19. The wearable communication device of claim 18, wherein said microphone for converting audio signals of a user wearing said wearable communication device into electrical signals for said transmission of said radio waves through said antenna.

20. The wearable communication device of claim 19, wherein said microphone is selected from a group consisting of a directional microphone, a microphone array, an omni-directional microphone, a miniature microphone, and a MEMS microphone.
